(19) United States
(12) Patent Application Publication
(10) Pub. No.: US 2023/0351387 A1
(43) Pub. Date: Nov. 2, 2023

(54) INFORMATION PROCESSING SYSTEM, DEVICE, AND METHOD

(71) Applicant: AXELL CORPORATION, Tokyo (JP)

(72) Inventor: Yusuke HOSHIZUKI, Tokyo (JP)

(73) Assignee: AXELL CORPORATION, Tokyo (JP)

(21) Appl. No.: 18/349,829

(22) Filed: Jul. 10, 2023

Related U.S. Application Data
(63) Continuation of application No. PCT/JP2021/039284, filed on Oct. 25, 2021.

(30) Foreign Application Priority Data
Jan. 15, 2021 (JP) 2021-005100

(51) Int. Cl. G06Q 20/40; G06Q 20/02

(52) U.S. Cl. CPC G06Q 20/4014; G06Q 20/02

(57) ABSTRACT

An information processing system includes a first apparatus and a second apparatus. The first apparatus includes a decision unit and a first publicizing unit. The decision unit decides secret information. The first publicizing unit publicizes a first transaction including limitation information enabling retrieving of crypto-assets by using the secret information on a distributed ledger. The second apparatus includes a receiving unit, a second publicizing unit, and an executing unit. The receiving unit receives the secret information. The second publicizing unit receives crypto-assets when the secret information is received by the receiving unit after the first transaction is publicized on a distributed ledger and by publicizing a second transaction including the secret information received by the receiving unit on a distributed ledger. The executing unit performs a predetermined operation in response to reception of the secret information by the receiving unit.

This application is a continuation of and claims priority to International Application No. PCT/JP2021/039284, International Filing Date Oct. 25, 2021, entitled Payment System, Payment Device, Payment Method, and Payment Program, which claims priority to Japanese Application No. 2021-005100 filed Jan. 15, 2021, both of which are incorporated herein by reference in their entireties.

### FIELD OF THE INVENTION

The embodiments discussed herein are related to an information processing system, an information processing apparatus, an information processing method.

### BACKGROUND OF THE INVENTION

Crypto-assets based on a distributed ledger such as a blockchain has been utilized for payment at stores and the like in town (for example, Japanese Laid-open Patent Publication No. 2020-129752).

In payment using crypto-assets, a sending transaction to transfer crypto-assets to a store needs to wait for approval on a blockchain, for example, and it takes time such as several minutes.

In order to avoid a sending history of crypto-assets being canceled, it is preferable to wait for further progressing of approval of a certain amount of blocks. This is because it is theoretically possible to create a history that there has been no sending transaction, and by progressing mining at a sufficient hash-rate, to cancel a sending transaction that has been once approved and taken in a blockchain.

Although cancelation of a sending history cannot be prevented from happening completely, blockchains have a characteristic that as the number of blocks (the number of approvals) with which mining has progressed after being taken in a blockchain is increased, the probability of succeeding cancelation of a transaction rapidly decreases. Therefore, although it is difficult to completely prevent cancelation of a sending history from happening, it is possible to deem that cancelation of a sending history is made impossible by waiting for a sufficient number of approvals.

However, due to this characteristic, when a price for items or services provided at a store is to be paid with crypto-assets, in order to securely perform sending of crypto-assets to the store, the purchaser has to wait until a sufficient number of blocks are approved.

Conventional payment with crypto-assets inconveniences its users mainly in terms of time, so that it has not been necessarily practical.

### SUMMARY OF THE INVENTION

According to an aspect of the embodiments an information processing system includes a first apparatus and a second apparatus. The first apparatus includes a decision unit and a first publicizing unit. The decision unit decides secret information. The first publicizing unit publicizes a first transaction including limitation information enabling retrieving of crypto-assets by using the secret information on a distributed ledger. The second apparatus includes a receiving unit, a second publicizing unit, and an executing unit. The receiving unit receives the secret information. The second publicizing unit receives crypto-assets when the secret information is received by the receiving unit after the first transaction is publicized on a distributed ledger and by publicizing a second transaction including the secret information received by the receiving unit on a distributed ledger. The executing unit performs a predetermined operation in response to reception of the secret information by the receiving unit.

The objects and advantages of the invention will be realized and achieved by the elements and combinations specifically pointed out in the claims.

It is to be understood that both the foregoing general description and the following detailed description are exemplary and illustrative and are not intended to limit the invention as claimed.

### BRIEF DESCRIPTION OF THE DRAWINGS

FIG. 1 is a diagram illustrating an example of a network configuration according to the present embodiment.

FIGS. 2A and 2B are diagrams illustrating an example of trade information on crypto-assets.

FIG. 3 is a diagram illustrating an example of processes of atomic swap.

FIG. 4 is an explanatory diagram of a flow of payment processing in the present embodiment.

FIG. 5 is a flowchart for explaining the payment processing described with reference to FIG. 4.

FIG. 6 is a block diagram illustrating functions a purchaser device has.

FIG. 7 is a block diagram illustrating functions a payment device has.

FIG. 8 is a block diagram illustrating an example of a computer device.

### DESCRIPTION

An embodiment of the present invention will be described below in detail with reference to the accompanying drawings.

A system according to the present embodiment is a payment system (an information processing system) using a distributed ledger.

The distributed ledger holds data having a configuration capable of detecting tampering using electronic signatures and hash pointers in a plurality of nodes distributed on a network.

The distributed ledger is, for example, a blockchain or a DAG (Directed acyclic graph). In the following descriptions, as an example, the distributed ledger is described as a blockchain.

In the DAG, when a user has created a transaction, a previously publicized unapproved transaction is approved. The transaction created by the user is also approved by an unapproved transaction publicized later. There is employed a consensus algorithm such that, upon being approved directly or indirectly by unapproved transactions the number of which is equal to or larger than a threshold, the transaction created by the user is deemed to be agreed on a network.

As described above, the DAG can employ a transaction structure equivalent to that of a blockchain, although the DAG is different in terms of its consensus algorithm from that of the blockchain described below.

Therefore, processing using a blockchain as a distributed ledger and processing using a DAG as a distributed ledger can be performed by using transactions having mutually the same configuration. Accordingly, processing using a blockchain as a distributed ledger described below can be performed as processing using a DAG as a distributed ledger.

First, as an element technology to realize the payment system according to the present embodiment, a blockchain and sending of crypto-as sets are summarized.

### [Blockchain]

A blockchain is a database that generates blocks each including a plural pieces of trade information and couples the generated blocks so as to record data in a distributed network.

In addition to plural pieces of trade information, each of the blocks includes a hash value indicating contents of a block generated immediately before, so that the blockchain has a data structure in which generated blocks are connected to one another along with a time series. It is a basic technology of crypto-assets (virtual currency) represented by Bitcoin, Monacoin, Ethereum, and the like.

Asset trading is expressed in a data format as “transaction” and it is shared on a P2P network. An operation of collecting transactions in its entirety in a Merkle tree and searching for Nonce in which a hash value generated by collecting a root node (a Merkle root) of the Merkle tree, a hash value of a previous block, an arbitrary value referred to as “Nonce”, and the like is equal to or smaller than a certain value is referred to as “mining”.

When mining is successful, a mining reward is given. A mechanism in which, because the amount of calculation resources provided for mining increases for the purpose of gaining the mining reward, the older the data is, the more difficult the tampering becomes, is referred to as “PoW (Proof of Work) blockchain system”.

A mechanism in which a certain reward is given in this manner so that resources to guarantee the credibility of database are provided is referred to as “blockchain”.

Other than PoW blockchain, Pos blockchain, PoI blockchain, and PoC blockchain are also applicable; however, explanations thereof are omitted.

[Mechanism of sending of crypto-as sets]

Crypto-assets that are currently in the mainstream are roughly divided into two types. These are Litecoin, Monacoin, and the like derivatively developed from Bitcoin and Rootstock and the like derivatively developed from Ethereum.

In the former example, the substance of crypto-assets is unspent transaction output (UTXO).

Normally, UTXO is locked so it can be only unlocked with an electronic signature using an elliptic curve cryptosystem referred to as ECDSA. Further, normally, a public key corresponding to a private key is written in UTXO so as to enable only an owner having a specific private key to unlock it.

Sending of crypto-assets is realized by giving an ECDSA electronic signature corresponding to a public key written in UTXO to unlock it, connecting to input of a new transaction, and writing a public key of a sending destination owner in UTXO of the new transaction.

In practice, UTXO has an area referred to as ScriptPubKey, and a program written in a programming language referred to as Script is written in the area. The input of a transaction attempting to connect to the UTXO has an area referred to as ScriptSig, and when the two areas match each other, the UTXO is unlocked.

Ethereum and crypto-assets derived therefrom can realize a mechanism equivalent to that described here by using a smart contract.

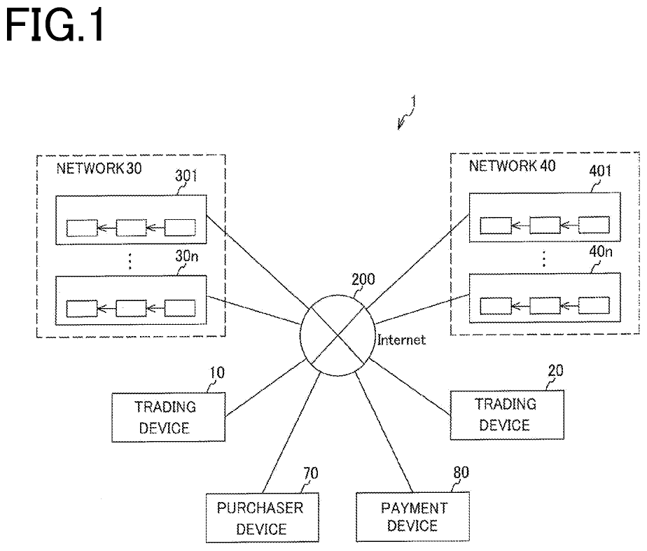

FIG. 1 is a diagram illustrating an example of a network configuration according to the present embodiment.

A network includes a purchaser device 70, a payment device 80, a network 30, a network 40, and a network 200. The purchaser device 70, the payment device 80, the network 30, and the network 40 are connected to one another in a mutually communicable manner via the network 200.

The network illustrated in FIG. 1 includes a trading device 10 and a trading device 20, and these devices are referenced in order to describe atomic swap that is used in the present embodiment as a reference.

Each of the trading device 10, the trading device 20, the purchaser device 70, and the payment device 80 is, for example, a computer device described below.

The network 30 and the network 40 are distributed networks such as a P2P network, and trade information is recorded in a blockchain.

In the following descriptions, as an example, it is described on the assumption that the network 30 employs, for example, Proof of Work (PoW) as a consensus algorithm of Bitcoin. Further, it is described on the assumption that the network 40 employs, for example, Proof of Work as a consensus algorithm of Litecoin.

A blockchain that records therein trades occurred in the network 30 is also referred to as “blockchain of Bitcoin”. Further, a blockchain that records therein trades occurred in the network 40 is also referred to as “blockchain of Litecoin”. The network 30 and the network may respectively employ other types of consensus algorithms such as Proof of Stake (PoS), Proof of Importance (PoI), and Proof of Consensus (PoC).

In the network 30, a plurality of node devices 301 to 30n that perform mining are communicably connected to one another. In the following descriptions, when the node devices 301 to 30n are not specifically distinguished from one another, these are referred to as “the node device 300”. Further, when node devices 401 to 40n are not specifically distinguished from one another, these are referred to as “the node device 400”.

In Proof of Work, mining is an operation of, as a hash function is applied to data of blocks while Nonce included in the blocks is changed, searching for Nonce with a hash value in which a predetermined number or more of 0 s are arranged (hereinafter, also “correct Nonce”). Data of blocks includes a hash value of data of a previous block to which the block is coupled, Nonce, and trade information.

When generating the block, a node device verifies transactions included in the block. Subsequently, the node device approves a correct transaction, includes the approved transaction in the block to perform an operation of searching for Nonce. Upon finding correct Nonce, the node device generates a block including the correct Nonce and couples a newly generated block to a blockchain held in the node device. Further, the node device transmits the newly generated block to a network of the blockchain. Thereafter, the newly generated block is also coupled to a blockchain held in another node device that is connected to the network. With this process, the transaction is recorded in the blockchain. In the following descriptions, a fact that a block including a transaction is coupled to a blockchain is also referred to as “a transaction is recorded in a blockchain”.

Connection of the network 200 is not limited to the network 30 and the network 40 and the network 200 may be also connected to other networks. Further, in addition to the purchaser device 70 and the payment device 80, the network 200 may be also connected to other trading devices.

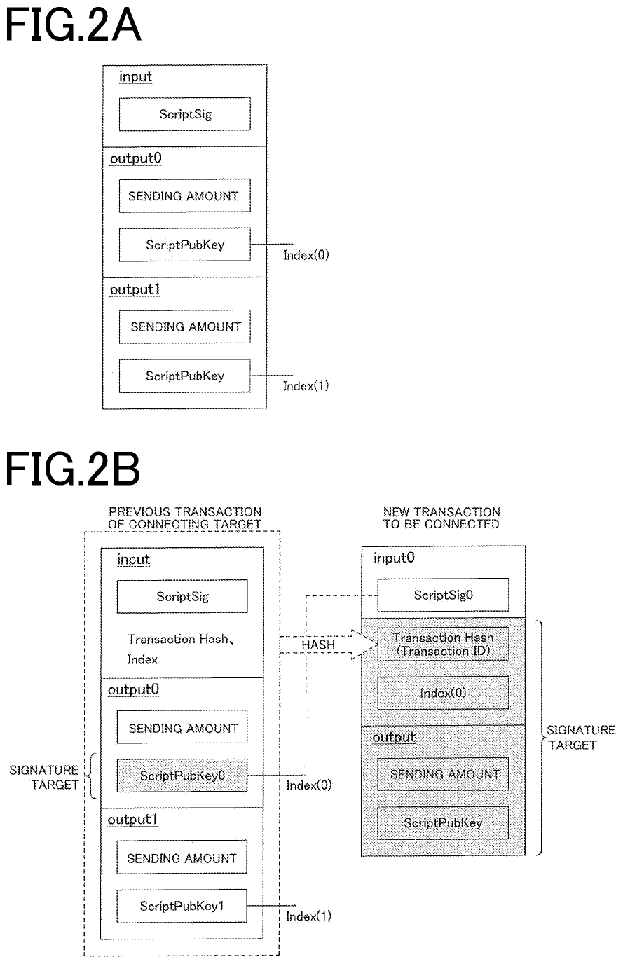

FIG. 2 are diagrams illustrating an example of trade information on crypto-assets.

FIG. 2(a) is an explanatory diagram of a structure of trade information. FIG. 2(b) is an explanatory diagram of a process of connecting trade information. The trade information is a transaction used for a process in which delivery and reception of crypto-assets are performed to transfer the ownership of the crypto-assets.

In the following descriptions, it is assumed that a P2PKH (Pay to Public Key Hash) is used as a transaction script. When a P2PK (Pay to Public Key) is used as a transaction script, ScriptPubKey that locks UTXO includes a public key of a user on a transmission destination who is a recipient of UTXO. Further, in the P2PK, ScriptSig that unlocks UTXO includes an electronic signature generated by using a private key of a user on a transmission source who is a provider of UTXO and creates a transaction.

UTXO is output of an unspent transaction that is not used as input of a transaction. UTXO is an ownership of crypto-assets and is used as input of the next transaction. Therefore, sending of crypto-assets is a process in which UTXO is used by a sender and UTXO only usable by a receiver is created. The input of a transaction is information for processing usage of crypto-assets. The output of a transaction is information for processing use of crypto-assets. UTXO is an abbreviation of Unspent Transaction Output.

An electronic signature is a value obtained by encrypting, with a private key of a user on a transmission source who creates a transaction, data except for ScriptSig of a transaction and a value for an electronic signature obtained by using ScriptPubKey of a previous transaction. The previous transaction is a transaction that includes output that is connected to input of a transaction created by the user on the transmission source at the time of remittance, and describes information on remittance to the user on the transmission source. The value for an electronic signature is, for example, a value obtained by applying a hash function to data except for ScriptSig of a transaction and data including ScriptPubKey of a previous transaction.

A configuration of a transaction is described with reference to FIG. 2(a).

A transaction is trade information in which transfer of the ownership of crypto-assets is summarized. The transaction includes input and output.

The input is information for unlocking UTXO of a previous transaction owned by a user on a transmission source who creates a transaction. The input includes ScriptSig.

ScriptSig is a program for unlocking UTXO owned by the user on the transmission source. The ScriptSig includes an electronic signature and a public key of the user on the transmission source. The electronic signature and the public key included in ScriptSig are values generated by using a private key of the user on the transmission source.

The output is information indicating transfer of the ownership of crypto-assets. The output includes a sending amount and ScriptPubKey.

ScriptPubKey is a program in which conditions to unlock output of a transaction are defined. ScriptPubKey includes a hash value of a public key generated by using a private key of a user on a transmission source (hereinafter, also “public key hash”).

A process of connecting transactions is described with reference to FIG. 2(b). In the following descriptions, as an example, a process in which output0 of a previous transaction as a connection target is connected to a new transaction is described. Each transaction is assumed to be processed in the network 30.

The output of a previous transaction includes output0 having a sending amount and ScriptPubKey0 and output1 having a sending amount and ScriptPubKey1. Output0 and output1 are associated with Index0 and Index1, respectively. Index0 and Index1 are identifiers to respectively identify output0 and output1.

Input0 of a new transaction is connected to output0 of a previous transaction. Since any input of a new transaction and other transactions is not connected to output1 of a previous transaction, it is in a state of UTXO.

Input0 of a new transaction includes ScriptSig, a transaction hash of a previous transaction, and Index0 as an identifier of output of the previous transaction.

ScriptSig0 includes an electronic signature and a public key used for a process of unlocking output0 of the previous transaction. For example, the electronic signature is generated by encrypting, by using a private key, a value for an electronic signature obtained by using data except for ScriptSig0 of the new transaction and ScriptPubKey0 included in output0 of the previous transaction. At this time, as the private key, a private key of a user who creates a new transaction is used.

A transaction hash is a hash value of the previous transaction in its entirety. The transaction hash is used as a transaction ID for identifying the previous transaction. Index0 is an identifier to identify output0 of a connection target in the previous transaction.

The process of connecting output0 included in the previous transaction and input0 included in the new transaction described above is described. In the following descriptions, it is assumed a case where the previous transaction is in a state of being recorded in a blockchain of Bitcoin.

A trading device creates a new transaction and transmits the new transaction to the network 30 to thereby store the new transaction in a memory pool that is provided in each node device 300 and stores therein unverified transactions. With regard particularly to Bitcoin and other coins derived therefrom, the node device 300 verifies, at the timing when the new transaction is stored in the memory pool, the stored new transaction. At the time of verification, the node device 300 references a transaction ID and Index0 of the new transaction and searches for transactions on a blockchain. The node device 300 finds a previous transaction corresponding to the transaction ID and then finds output0 corresponding to Index0.

Thereafter, the node device 300 couples ScriptSig0 included in input0 and ScriptPubKey0 included in output0 to each other. With this process, the node device 300 performs a first verification to verify matching between a hash value of a public key included in ScriptSig0 and a public key hash included in ScriptPubKey0. Further, the node device 300 performs a second verification to verify an electronic signature by using an electronic signature and a public key included in ScriptSig0. Upon approval of the first verification and the second verification, the node device 300 connects output0 of a previous transaction and input0 of a new transaction to each other.

Subsequently, the node device 300 includes the approved new transaction in a block to perform an operation of searching for Nonce. Upon finding correct Nonce, the node device 300 generates a block including the correct Nonce and couples the newly generated block to a blockchain held in the node device 300. Further, the node device 300 transmits the newly generated block to a network of the blockchain. Another node device 300 in the network having received this block adds the block to data included in the node device itself after verifying that Nonce in the block is correct Nonce. With this process, the newly generated block is also coupled to blockchains held in other node devices connected to the network and a new transaction is recorded in the blockchains.

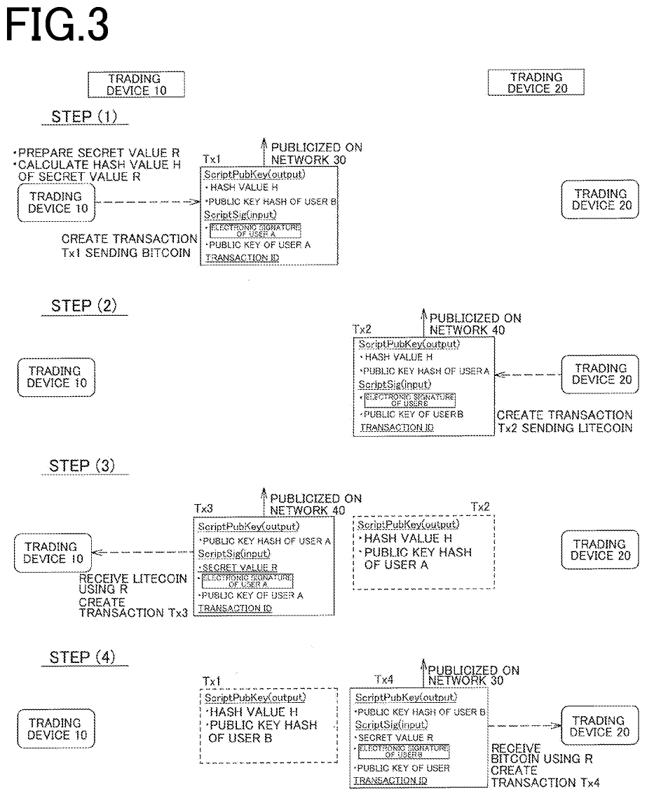

FIG. 3 is a diagram illustrating an example of processes of atomic swap.

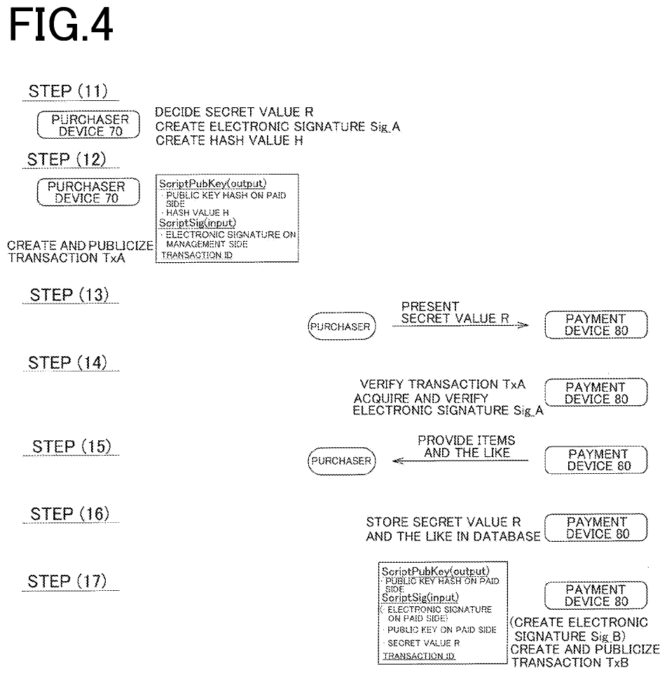

A payment method according to the present embodiment described with reference to FIG. 4 onwards is a method to which the mechanism of atomic swap is applied.

Accordingly, prior to describing the payment method according to the present embodiment, a process of atomic swap is described with reference to FIG. 3.

As an assumption, there are multiple types of crypto-assets each having different characteristics. Therefore, when a user uses crypto-assets, crypto-assets suitable for his usage are selected. The types of crypto-assets include, for example, Bitcoin (BTC: registered trademark), Ethereum (ETH: registered trademark), Litecoin (LTC), and Monacoin (MONA: registered trademark). Usages of crypto-assets include, for example, preserving values, purchasing items, and fees for managing contract details.

As described above, since multiple types of crypto-assets are suitably used according to usage, trades for exchanging different types of crypto-assets are made. Trades for exchanging different types of crypto-as sets include a direct trade that is a trade made between users directly and an intermediary trade that is a trade made between users through a third party such as an exchange.

The direct trade of crypto-assets is described.

For example, when a user A conducts an exchange trade between Bitcoin he owns and Litecoin owned by a user B, the user A sends his Bitcoin to the user B. Subsequently, upon confirmation that Bitcoin is delivered from the user A, the user B sends his Litecoin to the user A.

In the direct trade, after confirmation that Bitcoin is delivered from the user A, the user B may be able to abscond the Bitcoin without sending his Litecoin to the user A. Therefore, the user A needs to send his Bitcoin to a trading counterpart on the assumption that the trading counterpart can be trusted.

The intermediary trade of crypto-assets is described.

For example, the user A deposits Bitcoin he owns to an exchange. The user B also deposits Litecoin he owns to the exchange. The exchange then sends Litecoin the user B has deposited to the user A and sends Bitcoin the user A has deposited to the user B. In the intermediate trade, since the user A and the user B deposit their crypto-assets to the exchange, there is a risk that the crypto-assets are stolen by illegal trading committed in the exchange, hacking into the exchange, and the like. Further, in the intermediary trade, since an exchange is used, there is a case where fees are more expensive as compared to those of the direct trade. Therefore, the user A needs to deposit his Bitcoin to the exchange on the assumption that the exchange can be trusted and fees are more expensive.

In order to solve such problems, there has been used atomic swap that enables users to conduct a direct trade without their crypto-assets being absconded even if it is a trade between non-credible individuals.

When two individuals conduct exchange of crypto-assets by using mutually different blockchains, if their crypto-assets are simply sent to each other between the user A and the user B, there is no guarantee that sending from the user A to the user B and sending from the user B to the user A are performed at the same time. This problem is caused by a fact that the time until approval is made is different among blockchains, a fact that the timings of transmitting each other's crypto-assets are different, and the like.

Further, a sending transaction before approval is made can be withdrawn. In other words, it is possible for one of the trading parties to abscond his counterpart's crypto-assets by making only one trade approved before the other trade valid and then withdrawing the other trade.

In Bitcoin and blockchain systems derived therefrom, atomic swap uses a programming language referred to as Script in which unlocking conditions of UTXO is written. Further, atomic swap uses a mechanism that an instruction set of Script includes an instruction to demand SHA256 that is a one-way hash function and an instruction to compare values.

Specifically, exchanging of crypto-assets between the user A and the user B is conducted with the following procedure.

In the following descriptions, as an example, a process of exchanging Bitcoin owned by a trading counterpart and Litecoin owned by a user is described. While a process of generating a secret value R by the trading device 10 is described, it is also possible to configure that a trading device of the user B generates the secret value R. That is, it is possible to configure that processes performed by the trading device of the user A described below are performed by the trading device of the user B, and processes performed by the trading device of the user B are performed by the trading device of the user A. Further, for ease of explanations, it is assumed that output of each transaction includes one piece of output and descriptions on a process of referencing output according to Index are omitted. The quantity of crypto-assets to be exchanged (exchanging quantity) may be decided before the process of atomic swap between a user and a trading counterpart based on an exchange rate and the like. Further, the user and the trading counterpart may exchange each other's address and public key before the process of atomic swap. The user A and the user B may decide the exchanging quantity of crypto-assets and may exchange each other's address and public key with arbitrary communication means such as providing e-mails and recording medium.

Step (1) The user A specifies the secret value R with random numbers and calculates a hash value H (constraint information) of the secret value R.

The user A issues a transaction Tx1 with unlocking conditions “one of parameters is an electronic signature corresponding to a public key of the user B (that is, the recipient is the user B) and the SHA256 hash value of the other parameter is the hash value H” and waits for approval.

The user B can acknowledge the hash value H since the approved transaction Tx1 is publicized on a blockchain.

That is, the trading device 10 of the user A generates the secret value R randomly. Further, the trading device of the user A applies a hash function to the secret value R to generate the hash value H. The hash function to be used when the trading device of the user A hashes the secret value R is, for example, a one-way hash function such as SHA-2, MD5, and SHA-1. With regard particularly to Bitcoin-based crypto-assets, a hash function referred to as RIPEMD-160 can be used to generate the hash value H.

When SHA-2 is used as a hash function, the hash value H is calculated by applying SHA256 twice. The reason for applying SHA256 twice upon calculation of the hash value H is that Script described above has such an instruction, but the application of SHA256 may be only once.

Further, the trading device 10 of the user A creates the transaction Tx1 to send Bitcoin to the user B. The trading device of the user A then transmits the created transaction Tx1 to the network 30. With this process, the transaction Tx1 is publicized on the network 30.

Input of the transaction Tx1 includes ScriptSig having an electronic signature of the user A and a public key of the user A and a transaction ID of a previous transaction including UTXO to be unlocked. The UTXO to be unlocked with ScriptSig of the transaction Tx1 is UTXO owned by the user A. The electronic signature of the user A and the public key of the user A are generated by using a private key owned by the user A.

Output of the transaction Tx1 includes ScriptPubKey having the hash value H and a public key hash of the user B. The public key hash of the user B is generated by using a public key of the user B. The public key hash of the user B is a hash value obtained by applying a hash function to the public key of the user B.

Step (2)

The user B similarly issues a transaction Tx2 with unlocking conditions “one of parameters is an electronic signature corresponding to a public key of the user A (that is, the recipient is the user A) and the SHA256 hash value of the other parameter is H” and waits for approval.

That is, the trading device 20 of the user B creates the transaction Tx2 in order to send Litecoin to the user A. The trading device of the user B then transmits the created transaction Tx2 to the network 40. With this process, the transaction Tx2 is publicized on the network 40.

Input of the transaction Tx2 includes ScriptSig having an electronic signature of the user B and a public key of the user B and a transaction ID of a previous transaction having UTXO to be unlocked. The UTXO to be unlocked with ScriptSig of the transaction Tx2 is UTXO owned by the user B. The electronic signature of the user B and the public key of the user B are generated by using a private key owned by the user B.

Output of the transaction Tx2 includes ScriptPubKey having the hash value H and a public key hash of the user A. The public key hash of the user A is generated by using a public key of the user A. The public key hash of the user A is a hash value obtained by applying a hash function to the public key of the user A. When the transaction Tx1 is publicized on the network 30, the hash value H is acquired from the transaction Tx1 by the trading device of the user B and is written in the output of the transaction Tx2.

Step (3)

The user A confirms that the transaction Tx2 issued by the user B is approved so that withdrawal and tampering cannot be made.

The user A creates an electronic signature with a private key of the user A himself and uses UTXO of the transaction Tx2 issued by the user B as an unlocking parameter along with the secret value R to perform remittance to the user A himself. That is, the trading device 10 of the user A creates a transaction Tx3 used for receiving Litecoin from the trading device of the user B. The trading device of the user A then transmits the created transaction Tx3 to the network 40. With this process, the transaction Tx3 is publicized to the network 40.

Since the transaction Tx3 is approved to prevent tampering and the secret value R is publicized on a blockchain as data in the transaction Tx3, the user B can acknowledge the secret value R. In practice, the transaction Tx3 described above is publicized on the network 40, and at the time when the transaction Tx3 enters a memory pool of each node device 400, the user B can acknowledge the secret value R even before the transaction Tx3 is approved.

Input of the transaction Tx3 includes ScriptSig having the secret value R, a public key of the user A, and an electronic signature of the user A and a transaction ID for identifying the transaction Tx2 having UTXO to be unlocked.

Output of the transaction Tx3 includes ScriptPubKey having a public key hash of the user A.

As a process of transferring the ownership of Litecoin sent by the user B to the user A, as an example, a process of unlocking UTXO of the transaction Tx2 by using the transaction Tx3 and locking the unlocked UTXO to an address of the user A is described. The address of the user A is, for example, a value obtained by converting a public key hash of the user A.

When the transaction Tx3 is transmitted to the network 40, the node device 400 references UTXO (output) of the transaction Tx2 corresponding to a transaction ID included in the transaction Tx3. Further, the node device 400 applies a hash function to the secret value R included in ScriptSig of the transaction Tx3 to calculate a hash value. Subsequently, the node device 400 performs a first verification to verify whether the calculated hash value and the hash value H included in ScriptPubKey of the transaction Tx2 match each other. The hash function used when the node device 400 calculates a hash value of the secret value R is a hash function same as a hash function used when the trading device of the user A hashes the secret value R.

The node device 400 calculates a hash value obtained by applying a hash function to a public key of the user A included in ScriptSig of the transaction Tx3. Subsequently, the node device 400 performs a second verification to verify whether the calculated hash value and a public key hash of the user A included in ScriptPubKey of the transaction Tx2 match each other. Further, the node device 400 performs a third verification to verify an electronic signature by using the electronic signature of the user A included in ScriptSig of the transaction Tx3 and the public key of the user A.

When the first verification, the second verification, and the third verification are successful, the node device 400 locks UTXO of the transaction Tx2 to the address of the user A. That is, the node device 400 creates output indicating that the user A has received Litecoin and locks the created output as UTXO included in the transaction Tx3 and owned by the user A. With this process, the ownership of the Litecoin is transferred from the user B to the user A.

When the output of the transaction Tx1 is still UTXO after passage of a predetermined time, ScriptPubKey of the transaction Tx1 may include a program for performing a process of refunding Bitcoin to the user A by using a public key of the user A. With this configuration, when a trade is not established, the trading device of the user A can refund Bitcoin to the address of the user A after passage of a predetermined time. In the following descriptions, a program for performing a process of refunding crypto-assets is also referred to as “refund script”. Meanwhile, when a trade is established, a program for performing a process of transferring crypto-assets is also referred to as “redeem script”.

Step (4)

The user B unlocks UTXO of the transaction Tx1 with an electronic signature created with a private key of the user B himself along with the secret value R to perform remittance to the user B himself.

That is, the trading device of the user B acquires the secret value R included in the transaction Tx3 that is publicized on the network 40 by the user A, and create a transaction Tx4 used for receiving Bitcoin from the trading device of the user A. Subsequently, the trading device of the user B transmits the created transaction Tx4 to the network 30. With this process, the transaction Tx4 is publicized on the network 30.

Input of the transaction Tx4 includes ScriptSig having the secret value R, a public key of the user B, and an electronic signature of the user B and a transaction ID for identifying the transaction Tx1 having UTXO to be unlocked.

Output of the transaction Tx4 includes ScriptPubKey having a public key hash of the user B.

As to a process of transferring the ownership of Bitcoin having been sent by the user A to the user B, as an example, a process of unlocking UTXO of the transaction Tx1 by using the transaction Tx4 and locking the unlocked UTXO to an address of the user B is described. The address of the user B is, for example, a value obtained by converting a public key hash of the user B.

When the transaction Tx4 is transmitted to the network 30, the node device 300 references UTXO (output) of the transaction Tx1 corresponding to a transaction ID included in the transaction Tx4. Further, the node device 300 applies a hash function to the secret value R included in ScriptSig of the transaction Tx4 to calculate a hash value. Subsequently, the node device 300 performs a fourth verification to verify whether the calculated hash value and the hash value H included in ScriptPubKey of the transaction Tx1 match each other. The hash function used when the node device 300 calculates a hash value of the secret value R is a hash function same as a hash function used when the trading device of the user A hashes the secret value R.

Further, the node device 300 calculates a hash value obtained by applying a hash function to a public key of the user B included in ScriptSig of the transaction Tx4. Subsequently, the node device 300 performs a fifth verification to verify whether the calculated hash value and a public key hash of the user B included in ScriptPubKey of the transaction Tx1 match each other. Further, the node device 300 performs a sixth verification to verify an electronic signature by using the electronic signature of the user B and the public key of the user B included in ScriptSig of the transaction Tx4.

When the fourth verification, the fifth verification, and the sixth verification are successful, the node device 300 locks UTXO of the transaction Tx1 to the address of the user B. That is, the node device 300 creates output indicating that the user B has received Bitcoin and locks the created output as UTXO included in the transaction Tx4 and owned by the user B. With this process, the ownership of the Bitcoin is transferred from the user A to the user B.

ScriptPubKey of the transaction Tx2 may include a program for performing, when the output of the transaction Tx2 is still UTXO after passage of a predetermined time, a process of refunding Litecoin to the user B by using a public key of the user B. With this configuration, when a trade is not established, the trading device of the user B can refund Litecoin to the address of the user B after passage of a predetermined time.

ScriptPubKey indicating unlocking conditions of UTXO of the transactions Tx1 and

Tx2 respectively created by each of the trading devices of the user A and the user B is a program as described below.
1.OP_HASH256
2.OP_PUSH H
3.OP_EQUALVERIFY
4.OP_PUSH public key
5.OP_CHECKSIG

In the instruction group in 1. to 3., a hash value of a parameter is calculated to compare the calculated parameter to the hash value H. While 4. and 5. are in a P2PK (pay-to-pubkey) method that is the simplest remitting method, a P2PKH (pay-to-pubkey-hash) method may be also used. HASH256 is varied according to a hash function to be used. ScriptPubKey also has a pattern in which its instruction is divided into EQUAL and VERIFY.

The corresponding ScriptSig used for unlocking UTXO is as described below.
1.OP_PUSH electronic signature
2.OP_PUSH R

The secret value R is publicized at a timing where the user A has received it, since UTXO of the transaction Tx2 cannot be unlocked unless this ScriptSig is present.

Further, if the user A does not publicize the secret value R for some reason, both the user A and the user B cannot retrieve their crypto-assets, so that the ownership of their crypto-assets is in an undecided state. Therefore, in practice, a condition “Alternatively, after passage of a certain time, crypto-assets can be refunded with an electronic signature that corresponds to a public key of a sender.” is added.

That is, similarly to the above descriptions, ScriptPubKey of the sending transaction described below has the hash value H written therein. The recipient (destination) of crypto-assets publicizes the secret value R corresponding to the hash value H as described below within a certain time period so as to unlock UTXO of the sending transaction. Meanwhile, when the secret value is not publicized within a certain time period, the sender can reclaim crypto-assets as the recipient (destination) cannot unlock the UTXO. This mechanism is referred to as HTLC (Hashed Time-Locked Contracts).

Specifically, for example, ScriptPubKey is processed as follows. Note that descriptions on ScriptPubKey different from the following explanations are standardized in
BIP-199.
1.OP_IF
2.OP_HASH256
3.OP_PUSH H
4.OP_EQUALVERIFY
5.OP_PUSH destination public key
6.OP_CHECKSIG
7.OP_ELSE
8.OP_CHECKLOCKTIMEVERIFY
9.OP_PUSH sender public key
10.OP_CHECKSIG
11.OP_ENDIF

Branched with an IF instruction, two types of ScriptSig described later are accepted.

When a trade is progressed as normal, unlocking can be made with the following ScriptSig.
1.OP_PUSH electronic signature of destination private key
2.OP_PUSH R
3.OP_PUSH 1

This program is referred to as “redeem script”.

1 at the end is read by OP_IF to execute the first half program.

When the secret value R is not publicized for some reason, crypto-assets can be refunded with the following ScriptSig.
1.OP_PUSH electronic signature of sender private key
2.OP_PUSH 0

This program is referred to as “refund script”.
0 at the end is read by OP_IF, programs after OP_ELSE are executed, and crypto-assets are refunded. Note that since OP_CHECKLOCKTIMEVERIFY is included, the refunding needs to be performed after passage of a certain time.

In this example, since OP_HASH256 is used, the hash value H is assumed to be SHA256 (SHA256(R)), but when OP_SHA256 is used, the hash value H is SHA256(R).

Since there are several other instructions to calculate a hash function, the calculation method of the hash value H needs to be a method that complies with the corresponding instruction.

According to the procedures described above, in order for the user A to receive crypto-assets, the secret value R needs to be publicized and once the secret value R is publicized, the user B can also receive crypto-assets at the same time.

When the user A does not publicize the secret value R, the user A cannot receive crypto-assets of the user B, therefore it can be deemed that publicizing the secret value R is mandatory.

While atomic swap is originally a technology for exchanging crypto-assets between different types of blockchains in a trustless manner (not through a trusted third party), it is safe to say that the essence of the technology is that upon confirming provisional remittance, secret information is delivered and received so as to confirm remittance.

As atomic swap is observed from one direction, a transaction where an electronic signature of a recipient and a secret value R to be notified by a sender (purchaser) are two unlocking conditions is once created.

As the recipient makes connection to an unlockable transaction only with his electronic signature using the secret value R notified at the time of establishing a trade, remittance by atomic swap is completed.

In the present embodiment, by applying this mechanism, a payment system similar to credit card payment described below is realized. In addition, a waiting time of a user (purchaser) until completion of payment with regard to payment by sending of crypto-assets is eliminated and payment using crypto-assets is made to be more practical.

Credit card payment is divided into two stages, which are payment processing (hereinafter, simply “authorization”) and sales processing. In the authorization processing, a credit line of a credit card is secured. In the sales processing, actual payment is made within the secured credit line.

It is possible to deem that such a scheme of credit card payment and atomic swap have a fundamentally equivalent function.

As described below, the system according to the present embodiment issues transactions in two stages, which are pre-payment by a purchaser and payment by the payment device 80.

The purchaser performs pre-payment (remittance) as a first transaction TxA for pre-payment with an electronic signature and a secret value on an item providing side (paid side) as unlocking conditions is publicized. This process corresponds to a tentative reservation of crypto-assets, that is, authorization.

After passage of a certain time since then, that is, after a timing where rewriting of the first transaction TxA has become virtually impossible, the purchaser presents the secret value R to the item providing side (paid side). The paid side publicizes a second transaction TxB for payment by which the secret value R is publicized and the first transaction TxA is unlocked, so as to complete the payment.

As described above, at the timing where the purchaser presents the secret value R to the paid side, the first transaction TxA cannot be canceled. Therefore, as for the second transaction TxB, in a blockchain, there is no need to wait for the number of approvals to be increased and items or services can be provided by performing immediate payment. This is because, even if the second transaction TxB is canceled, the paid side publicize the second transaction TxB once again to receive crypto-assets.

As described above, in the present embodiment, by performing a process corresponding to credit card authorization on a blockchain, crypto-assets are tentatively reserved. By guaranteeing an intention to remit with the blockchain, the providing side can provide items or services with a sense of security.

Thereafter, remittance is confirmed by delivering secret information (the secret value R) from the purchaser to the paid side, so that the start of the time taken for remittance approval is as far back as the timing of the tentative reservation.

Therefore, for example, in payment such as that at a café and the like where there is a time lag between providing services and payment therefor that can take a long enough time since a tentative reservation, the waiting time for approval can be none in appearance.

Approval of the first transaction TxA with regard to authorization is completed during a time where the purchaser is being provided with items or services, so that there is no need to wait unnecessarily from the start to completion of payment by presenting the secret value R and thus it is possible to greatly improve usability.

The payment system according to the present embodiment to which atomic swap is applied is described below.

In atomic swap, the secret value R cannot be reused unless double spending is made. Therefore, in the payment system according to the present embodiment, the secret value R is used as ID information for proving or identifying a fact that pre-payment or a tentative reservation is made while applying atomic swap in which different types of crypto-assets are exchanged on a blockchain or complying with these crypto-assets.

Since blockchains are established with a P2P system, they do not require any management database server that manages ID information. The payment system according to the present embodiment has an advantage that any cost on building a database server that manages ID information and on maintenance and operation management therefor is not imposed.

Differently from an exchanging trade of crypto-assets, among the networks illustrated in FIG. 1, only a network (here, the network 30) of crypto-assets used for remittance to the payment device 80 is used.

In the system illustrated in FIG. 1, the purchaser device 70 is a device such as a portable terminal used by a purchaser who is a user that purchases items or services.

The payment device 80 is a device that is installed in a store and the like where items or services are purchased. The payment device 80 may be a register operated by workers at a store or an automatic vending machine installed at a store.

A purchaser or the purchaser device 70 decides the secret value R and publicizes the first transaction TxA that requires the secret value R and an electronic signature of the payment device 80 (the recipient is limited to the payment device 80) for unlocking. The first transaction TxA is a transaction complying with the atomic swap described above.

Further, the first transaction TxA is a transaction for sending crypto-assets of an amount corresponding to the price of items or services to the payment device 80. In the first transaction TxA, a sending amount is written in ScriptPubKey (output) and an electronic signature of the purchaser device 70 is included.

The electronic signature of the purchaser device 70 may be written in input (ScriptSig) of the first transaction TxA or written in OP_RETURN as additional information.

When the payment device 80 is presented with the secret value R and confirms that the first transaction TxA includes an electronic signature of the purchaser device 70, the payment device 80 provides items, services, and the like to a purchaser.

Subsequently, the payment device 80 publicizes the second transaction TxB corresponding to the first transaction TxA including the secret value R.

The payment system according to the present embodiment is described below in detail.

In the present embodiment, authorization and payment are separated from each other by applying the technology of atomic swap.

For ease of explanations, it is assumed that output of each transaction in a remitting process via a blockchain includes one piece of output and descriptions on a process of referencing output according to Index are omitted.

FIG. 4 is an explanatory diagram of a flow of payment processing in a first example of the present embodiment.

In the following descriptions, it is assumed that a P2PKH is used as a transaction script.

At step (11), a purchaser himself creates the secret value R or uses a terminal device (the purchaser device 70) of the purchaser to decide the secret value R randomly. Further, the purchaser device 70 creates an electronic signature Sig_A from a private key Prk_A of the purchaser device 70. The purchaser device 70 generates the hash value H by applying a hash function to the decided secret value R.

At step (12), the purchaser device 70 creates the first transaction TxA.

The first transaction TxA is a transaction capable of performing unlocking on a condition that an electronic signature Sig_B of the payment device 80 and the secret value R are written in ScriptSig of a corresponding second transaction TxB. The recipient of the first transaction TxA is limited to the payment device 80.

A public key of the payment device 80 and the hash value H are written in ScriptPubKey of the first transaction TxA and the electronic signature Sig_A is written in ScriptSig.

The electronic signature Sig_A is written in ScriptSig of the first transaction TxA. The purchaser device 70 publicizes the created first transaction TxA on a blockchain (the network 30).

At step (13), the purchaser waits for the success probability of tampering on the blockchain on which the purchaser device 70 has publicized the first transaction TxA to be sufficiently low and then presents the secret value R to the payment device 80. The secret value R may be displayed as a QR code (registered trademark) or a barcode on a screen of a portable terminal (the purchaser device 70) the purchaser owns.

The reason for the purchaser waiting for the success probability of tampering on the blockchain on which the first transaction TxA is publicized to be sufficiently low is as follows. That is, by creating a new blockchain on which the first transaction TxA is not publicized and progressing mining at a large enough hash rate, it is theoretically possible to reuse crypto-assets on the assumption that there is no first transaction TxA taken in the blockchain. As the number of blocks (the number of approvals) in which mining has progressed is increased after a sending transaction is taken in the blockchain, the probability of succeeding cancelation of transaction rapidly decreases. Therefore, the purchaser presents the secret value R to the payment device 80 after waiting for a sufficient number of approvals being made, with which cancelation of transaction becomes virtually impossible.

The payment device 80 includes, for example, a reading device such a camera that scans a QR code (registered trademark) or a barcode printed on paper or displayed on a display screen of the purchaser device 70 to read the secret value R. For example, when a purchaser holds a QR code (registered trademark) or a barcode over a reading device, the payment device 80 can read the secret value R from the QR code (registered trademark) or the barcode.

The payment device 80 can be configured to include an insertion port into which a USB memory or the like having a secret value stored therein is inserted and to be capable of reading the secret value R from the USB memory or the like inserted into the insertion port.

At step (14), the payment device 80 verifies the publicized first transaction TxA.

When a hash value obtained by applying a hash value to the secret value R matches the hash value H included in the first transaction TxA, the first transaction TxA can be unlocked by using the secret value R, so the payment device 80 acquires an electronic signature described in the first transaction TxA.

The payment device 80 verifies the electronic signature written in the first transaction TxA to confirm a fact that the electronic signature Sig_A of the purchaser device 70 is given to the first transaction TxA. The payment device 80 may also confirm whether a sending amount of crypto-as sets of the first transaction TxA satisfies specified conditions (whether it is equal to or more than the price of items or equal to or more than a mining fee). The payment device 80 also confirms whether the presented secret value R is not memorized in the database described below.

The payment device 80 may also confirm whether the hash value H of the secret value R included in the first transaction TxA, a transaction ID of the first transaction TxA, and the electronic signature Sig_A are not memorized in the database described below.

At step (15), when the electronic signature Sig_A is given, the sending amount satisfies the conditions described above, and the secret value R and the like are new ones that are not memorized in a database, items or services are provided to a purchaser. For example, the payment device 80 as an automatic vending machine discharges items such as a beverage a purchaser requests to the purchaser through a discharge mechanism (not illustrated).

At step (16), the payment device 80 memorizes at least one of the secret value R, the hash value H of the secret value R, the transaction ID of the first transaction TxA, and the electronic signature Sig_A in a database provided in the payment device 80.

This is because there is a problem that double spending is made on the same secret value R or the same first transaction TxA. Such double spending is made by canceling the second transaction TxB for payment publicized by the payment device 80 described below. An individual who attempts to make double spending, after the second transaction TxB is canceled, uses the same secret value R to doubly obtain items or services from the payment device 80.

To handle this problem, the payment device 80 memorizes a list (history information) of a used secret value R, a used electronic signature, a transaction ID of the first transaction TxA, and the hash value H in a local database and the like. The payment device 80 can determine that the second transaction TxB is canceled when a secret value R same as that memorized in the database is presented.

When it is determined that the second transaction TxB is canceled, at step (16), it is possible to configure that the store side does not provide items or services.

Alternatively, the payment device 80 publicizes the second transaction TxB once again with the secret value R, the hash value H of the secret value R, the transaction ID of the first transaction TxA, and the electronic signature Sig_A memorized in a database.

Also on a global public chain, the payment device 80 not only holds a copy of the entire blockchain, but also simply confirms the secret value R and an electronic signature held in a local database so as to be able to counter double spending on the secret value R and the electronic signature attempted with cancelation of the second transaction TxB.

Further, after step (16), the payment device 80 may publicize the second transaction TxB to unlock the first transaction TxA.

At step (17), the payment device 80 creates the electronic signature Sig_B with a private key Prk_B of the payment device 80. The payment device 80 then creates the second transaction TxB.

A public key of the payment device 80 is written in ScriptPubKey of the second transaction TxB, and the electronic signature Sig_B, the public key of the payment device 80, and the secret value R are written in ScriptSig of the second transaction TxB.

Subsequently, the payment device 80 publicizes the created second transaction TxB on a blockchain (the network 30).

In the above descriptions, the purchaser having decided the secret value R presents the secret value R to the payment device 80 after waiting for the success probability of tampering to a blockchain on which the first transaction TxA is publicized to be sufficiently low. It can be said that the payment device 80 publicizes the second transaction TxB on a blockchain when the success probability of tampering on the first transaction TxA has become sufficiently low.

In the payment system according to the present embodiment, it is important that the purchaser holds the secret value R with which the first transaction TxA can be unlocked. Therefore, the payment device 80 performs specified processing (selling items) in response to a fact that the purchaser has presented the secret value R to the payment device 80.

After selling items or providing services, as the second transaction TxB is publicized on a blockchain, the payment device 80 can receive remittance through the first transaction TxA. Further, since history information (the secret value R, the hash value H, a private key, and a transaction ID) is recorded in the blockchain, sales records in the payment device 80 can be confirmed from outside.

Specified processing (selling items, providing services, and the like) may be performed after publicizing the second transaction TxB on a blockchain. That is, step (17) may be performed between step (14) and step (15).

As described above, the purchaser presents the secret value R to the payment device 80 after a timing where the probability of the first transaction TxA being canceled has become sufficiently low. Therefore, the payment device 80 may publicize the secret value R (the second transaction TxB) after providing items or services to the purchaser or may provide items and the like after publicizing the secret value R (the second transaction TxB).

In either cases, in the present embodiment, transactions in two stages are issued, which are a first transaction TxA for pre-payment (tentative reservation) and a second transaction TxB for payment.

As for the first transaction TxA, it is preferable to wait for a time until the number of approvals is increased sufficiently, whereas the second transaction TxB does not need to wait for it and items and services can be provided immediately on a condition that a secret value R same as the secret value R memorized in a database is not presented.

At the timing where mining on several blocks from the first transaction TxA has progressed, a tentative reservation cannot be canceled, so that the selling side can exchange items and the secret value R with a sense of security. Thereafter, the selling side can perform remittance by publicizing the second transaction TxB including the secret value R so that the sent crypto-assets can be owned by the selling side.

Further, in processing in which atomic swap is applied, there is an aspect that since the first transaction TxA cannot be received unless an electronic signature of the payment device 80 as well as the secret value R are provided, it is impossible to make double spending. It is not necessary for a purchaser to wait for a sufficient number of approvals of the second transaction TxB before items are provided, thereby improving usability.

If the second transaction TxB is canceled and a secret value R same as the secret value R memorized in a database is presented, the payment device 80 does not provide items or services. In this case, it suffices that the payment device 80 publicizes the second transaction TxB once again with the secret value R, the hash value H of the secret value R, the transaction ID of the first transaction TxA, and the electronic signature Sig_A which are memorized in a database.

The purchaser does not need to wait for a sufficient number of approvals with regard to the second transaction TxB before services are provided and thus payment usability can be significantly improved.

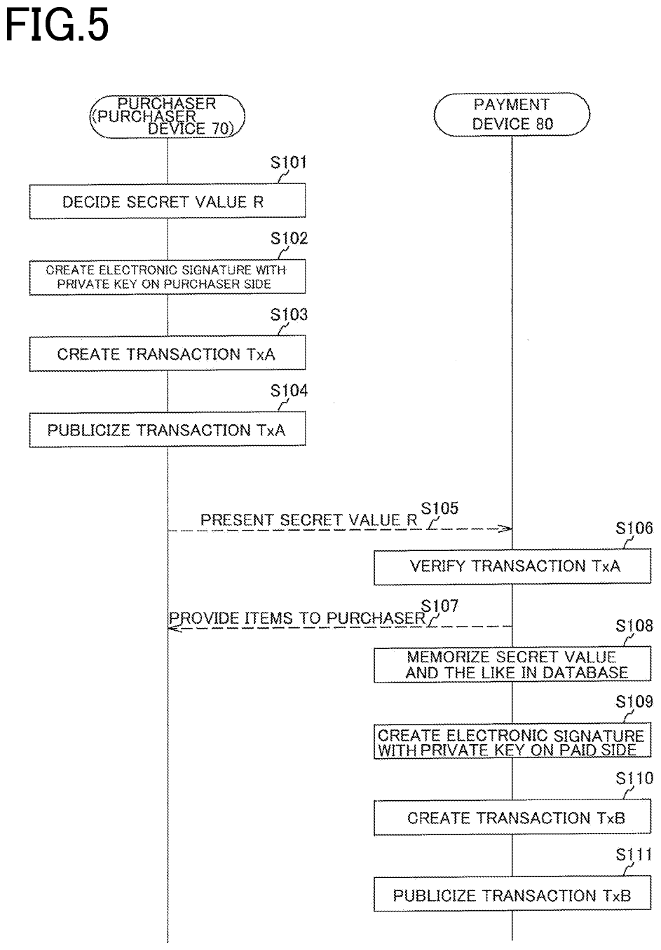

FIG. 5 is a flowchart for explaining the payment processing described with reference to FIG. 4.

At Step S101, the purchaser device 70 decides the secret value R randomly.

At Step S102, the purchaser device 70 creates the electronic signature Sig_A with the private key Prk_A on the purchaser side.

At Step S103, the purchaser device 70 creates the first transaction TxA in which the electronic signature Sig_A is written, and at Step S104, the purchaser device 70 publicizes the first transaction TxA on the network 30.

At Step S105, the purchaser device 70 presents the secret value R to the payment device 80.

At Step S106, the payment device 80 verifies the first transaction TxA.

At Step S107, the payment device 80 provides items or services to the purchaser.

At Step S108, the payment device 80 memorizes the secret value R and the like in a database.

At Step S109, the payment device 80 creates the electronic signature Sig_B with the private key Prk_B of the payment device 80.

At Step S110, the payment device 80 creates the second transaction TxB by using the electronic signature Sig_B created at Step S109 and the secret value R presented at Step S105.

At Step S111, the payment device 80 publicizes the second transaction TxB on the network 30 to unlock the first transaction TxA, thereby receiving sent crypto-assets.

As a modification of the embodiment described above, it is possible to perform “partial payment” in which a plurality of pre-payments are made, a part of the pre-payments is redeemed after passage of a certain time, and the rest of the pre-payments is allotted to an actual payment.

As described above, in atomic swap, it is a common procedure to add a condition that, after passage of a certain time, crypto-assets can be redeemed by using an electronic signature of a transmitter. By applying this condition, it is possible to make a larger number of tentative reservations (pre-payments) in advance and to make a payment only for an actually used amount of crypto-assets.

For example, at step (11) in FIG. 4, the purchaser creates ten first transactions TxA by which crypto-assets worth 100 Yen are pre-paid, and all the first transaction TxA are publicized at step (12). The same number of secret values R and hash values H thereof are created according to each of the first transactions TxA.

For example, the purchaser creates secret values R1 to R10 respectively corresponding to ten first transactions TxA by which crypto-assets worth 100 Yen are sent to calculate respective hash values H(R1) to H(R10). The hash values H(R1) to H(R10) are written in ScriptPubKey of each of the first transactions TxA.

In an actual payment, at step (13), for example, only secret values R corresponding to eight out of the ten first transactions TxA (for example, the secret value R3 to the secret value R10) are sent to the paid side.

At step (17), the payment device 80 publicizes eight second transactions TxB corresponding to eight secret values R to pay only 800 Yen among the pre-paid crypto-assets. Meanwhile, the first transaction TxA corresponding to the rest of 200 Yen can be refunded to the purchaser after passage of a certain time.

In the “partial payment” described above, it is possible to configure to generate a plurality of secret values R from one master. That is, one secret value X used as a master is prepared, and the value of each stage obtained by multiplying the secret value X by a one-way function (hash function) many times is used as a secret value of the first transaction

TxA.

For example, ten stages of hash functions with regard to a predetermined secret value X are calculated to obtain the following ten secret values R, which are R1 to R10.
R1=X
R2=H′(X)
R3=H′(H′(X))
R4=H′(H′(H′(X)))
R5=H′(H′(H′(X))))
R6=H′(H′(H′(H′(X)))))
R7=H′ (H′ (H′ ((H′ (H′ (X))))))
R8=H′(H′(H′(H′((H′(H′(X)))))))
R9=H′(H′(H′(H′(H′((H′(H′(X))))))))
R10=H′ (H′ (H′ (H′ (H′ (H′ ((H′ (H′ (X)))))))))

Similarly to the above descriptions, the hash values H(R1) to H(R10) of these secret values R1 to R10 are written in scriptPubKey of each first transaction TxA.

When R3=H′(H′(X)) on the third stage is notified to the payment device 80 at the time of making a payment, the payment device 80 can calculate the following seven secret values R4 to R10. Therefore, the payment device 80 can create the second transaction TxB that receives crypto-assets worth 800 Yen by using the secret values R3 to R10.

Meanwhile, since the hash function H′ is a one-way function, R2=H′(X) and R1=X cannot be calculated based on R3=H′(H′(X)). The payment device 80 cannot create the second transaction TxB that receives crypto-assets worth 200 Yen by using the secret values R1 and R2.

The purchaser can redeem the crypto-assets worth 200 Yen after passage of a predetermined time.

With the processing described above, only one secret value is required that is notified to the payment device 80 in “partial payment”.

This configuration can greatly save the troubles on the purchaser as compared to a case where a plurality of secret values are notified, and payment can be made more securely.

Note that the hash function at the time of generating the secret values R2 to R10(H′(X)) based on the secret value X of a master and the hash function used for generating the hash value H written in ScriptPubKey based on the secret values R1 to R10 may be different functions.

The purchaser device and the payment device are described below.

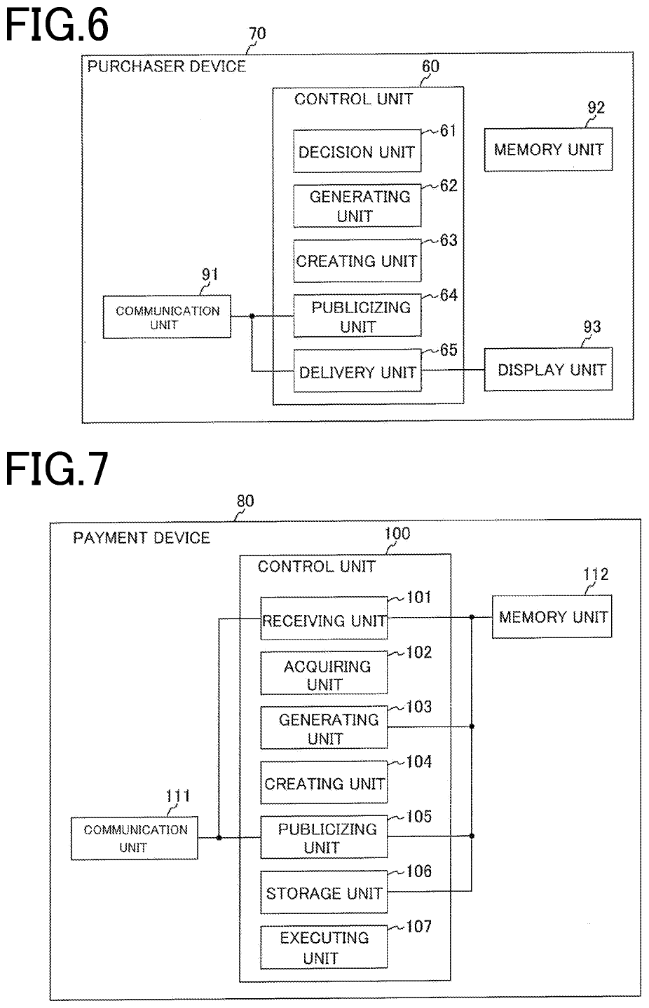

FIG. 6 and FIG. 7 are functional block diagrams illustrating an example of each device.

Each of the purchaser device 70 and the payment device 80 may have at least one or more functions other devices have.

FIG. 6 is a block diagram illustrating functions the purchaser device 70 has.

With reference to FIG. 6, functions of the purchaser device 70 are described.

The purchaser device 70 includes a control unit 60, a communication unit 91, a memory unit 92, and a display unit 93.

The control unit 60 includes a decision unit 61, a generating unit 62, a creating unit 63, a publicizing unit 64, and a delivery unit 65. The communication unit 91 connects the purchaser device 70 to networks. The memory unit 92 memorizes various types of information.

The decision unit 61 decides a secret value randomly.

The generating unit 62 generates an electronic signature based on the private key and generates the hash value H based on the secret value R. The generating unit 62 also generates a QR code (registered trademark) and the like based on the secret value R.

The creating unit 63 creates the first transaction TxA based on the generated electronic signature and the generated hash value H.

The publicizing unit 64 publicizes the first transaction TxA created by the creating unit 63 on the network 30.

The delivery unit 65 displays the generated QR code (registered trademark) and the like on the display unit 93 and delivers the secret value R to the payment device 80.

FIG. 7 is a block diagram illustrating functions the payment device 80 has.

With reference to FIG. 7, functions of the payment device 80 are described.

The payment device 80 includes a control unit 100, a communication unit 111, and a memory unit 112.

The control unit 100 includes a receiving unit 101, an acquiring unit 102, a generating unit 103, a creating unit 104, a publicizing unit 105, a storage unit 106, and an executing unit 107. The memory unit 112 memorizes various types of information.

The receiving unit 101 acquires the secret value R from a QR code (registered trademark), a barcode, or a token (USB memory) presented by a purchaser.

When the first transaction TxA can be unlocked by using the secret value R received by the receiving unit 101, the acquiring unit 102 acquires identification information (electronic signature) included in the first transaction TxA.

The generating unit 103 generates the electronic signature Sig_B based on a private key.

The creating unit 104 creates the second transaction TxB corresponding to the first transaction TxA.

The publicizing unit 105 publicizes the second transaction TxB created by the generating unit 103 on the network 30 to unlock the first transaction TxA, thereby receiving sent crypto-assets.

The storage unit 106 stores an electronic signature of the purchaser device 70 written in the first transaction TxA, the hash value H, the secret value R presented by a purchaser, and the like in a database provided in the memory unit 112.

The executing unit 107 performs processing such as controlling a predetermined discharge mechanism to discharge items in response to reception of the secret value R.

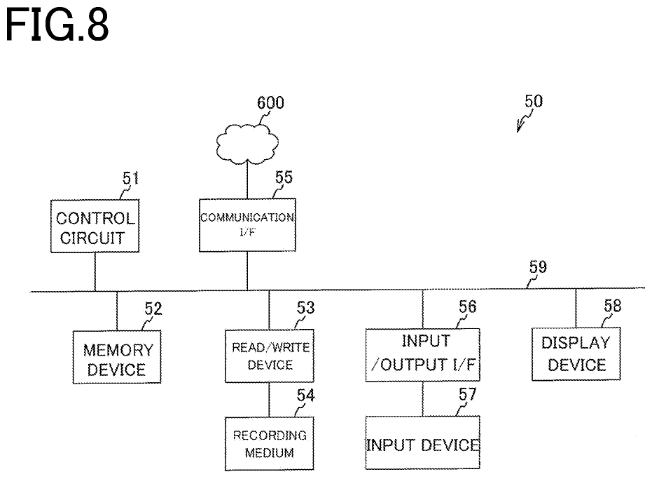

FIG. 8 is a block diagram illustrating an example of a computer device.

With reference to FIG. 8, a configuration of a computer device 50 is described.

In FIG. 8, the computer apparatus 50 is, for example, an information processing apparatus includes a control circuit 51, a memory device 52, a read/write device 53, a recording medium 54, a communication interface 55, an input/output interface 56, an input device 57, and a display device 58. The communication interface 55 is connected to a network 600. These constituent elements are connected to one another through a bus 59. The trading device 10, the trading device 20, the purchaser device 70, and the payment device 80 can be constituted by appropriately selecting a part or all of the constituent elements described in the computer apparatus 50.

The control circuit 51 controls the entirety of the computer apparatus 50. The control circuit 51 is, for example, a processor such as a Central Processing Unit (CPU), a Field Programmable Gate Array (FPGA), an Application Specific Integrated Circuit (ASIC), and a Programmable Logic Device (PLD). For example, the control circuit 51 functions as the control unit 60 in FIG. 6. Further, the control circuit 51 functions as the control unit 100 in FIG. 7.

The memory device 52 memorizes various types of data. The memory device 52 is, for example, a memory such as a Read Only Memory (ROM) and a Random Access Memory (RAM) or a Hard Disk (HD). The memory device 52 may memorize a payment program (an information processing program) for causing the control circuit 51 to function as at least one of the control unit 60 and the control unit 100. For example, the memory device 52 functions as the memory unit 92 in FIG. 6. Further, the memory device 52 functions as the memory unit 112 in FIG. 7.

The memory unit 112 includes a database that stores therein an electronic signature of the purchaser device 70 described in the first transaction TxA, the hash value H, the secret value R presented by a purchaser, and the like.

The purchaser device 70 and the payment device 80 reads out the payment program memorized in the memory device 52 on a RAM when payment processing is performed.

By executing the payment program read on the RAM with the control circuit 51, the purchaser device 70 performs payment processing including at least one of a deciding process, a generating process, a creating process, a publicizing process, and a delivery process.

Further, by executing the payment program read on the RAM with the control circuit 51, the payment device 80 performs payment processing including at least one of a receiving process, an acquiring process, the generating process, the creating process, the publicizing process, a storing process, and an executing process.

The payment program may be memorized in a memory device included in a server on the network 600 as far as the control circuit 51 can access the payment program via the communication interface 55.

The read/write device 53 is controlled by the control circuit 51 and performs read/write of data in the detachable recording medium 54.

The recording medium 54 stores therein various types of data. The recording medium 54 memorizes a payment program, for example. The recording medium 54 is, for example, a nonvolatile memory (non-transitory computer-readable recording medium) such as a Secure Digital (SD) memory card, a Floppy Disk (FD), a Compact Disc (CD), a Digital Versatile Disk (DVD), a Blu-ray (registered trademark) Disk (BD), and a flash memory.

The communication interface 55 communicably connects the computer apparatus 50 to other devices via the network 600. For example, in FIG. 6, the communication interface 55 functions as the communication unit 91. Further, for example, in FIG. 7, the communication interface 55 functions as the communication unit 111.

The input/output interface 56 is, for example, an interface that is connected to various types of input devices in a detachable manner. The input/output interface 56 communicably connects the various types of input devices connected thereto to the computer apparatus 50. The input/output interface 56 outputs a signal input from the various types of input devices connected thereto to the control circuit 51 via the bus 59. Further, the input/output interface 56 outputs a signal output from the control circuit 51 to an input/output device via the bus 59. The input device 57 is, for example, a touch panel, a code reader, a keyboard, and a mouse. Particularly, a code reader as the input device 57 connected to the input/output interface 56 may accept, for example, input of the secret value R via a QR code (registered trademark) or a barcode of the secret value R displayed on paper or a purchaser device.

The display device 58 displays various types of information. For example, the display device 58 functions as the display unit 93 illustrated in FIG. 6 and may display a QR code (registered trademark) or a barcode of the secret value R.

The network 600 is, for example, a LAN, wireless communication, a P2P network, or the Internet and communicably connects the computer apparatus 50 to other apparatus.

While a part of atomic swap is used in the payment system according to the embodiment described above, processing performed by the control unit 60 and the control unit 100 described above may be realized by using a smart contract. That is, the payment system according to the present embodiment may perform, by using a smart contract, the above-described payment processing such that “the purchaser device 70 sends crypto-assets by using a transaction by which the purchaser device 70 can receive crypto-assets as secret information (the secret value R) is publicized. Subsequently, the payment device 80 receives the crypto-assets by using secret information acquired from a purchaser in exchange for items”.

More specifically, the payment system according to the embodiment may realize the above-described payment processing by creating a smart contract having equivalent functions as those of atomic swap and using a part of processing of the created smart contract. That is, the purchaser device 70 publicizes a transaction for sending crypto-assets including the hash value H of secret information, with an address of a smart contract specified, on a distributed ledger. The payment device 80 publicizes a transaction for receiving crypto-assets including secret information specifies an address of a smart contract, with an address of a smart contract specified, on a distributed ledger. Subsequently, the payment system according to the embodiment executes a program corresponding to atomic swap with a smart contract. With this configuration, the payment system according to the embodiment may perform a process of sending crypto-assets to a seller automatically. In the following descriptions, the transaction for sending crypto-assets is simply referred to as “sending transaction”. Further, the transaction for receiving crypto-assets is simply referred to as “reception transaction”.

Further, the payment system according to the embodiment may publicize a code complying with a process procedure of HTLC (Hashed Time-Locked Contracts) on a distributed ledger as the code is implemented as a smart contract. In this case, the purchaser device 70 gives, as additional information of a sending transaction, a sending address of the payment device 80, the hash value H, and an address of the purchaser device 70 for refunding, publicizes the code on the distributed ledger, with an address of the smart contract specified. Further, the payment device 80 gives, as additional information of a reception transaction, an electronic signature on the paid side and secret information publicizes the code on the distributed ledger, with an address of the smart contract specified. With this process, the payment system according to the embodiment may perform processing corresponding to the payment processing described above by using a smart contract. Note that the code complying with a process procedure of HTLC is a unique code in HTLC processing. Further, additional information given by the purchaser device 70 and the payment device 80 is variable information in HTLC processing.

Further, when a code complying with a process procedure of HTLC is implemented as a smart contract, the payment system according to the embodiment may include at least one of a sending address of the payment device 80 and the hash value H in the code and fix it. That is, as the purchaser device 70 specifies an address of a smart contract and publicizes a sending transaction on a distributed ledger, remittance can be made by using a value specified with the smart contract.

The present embodiment is not limited to the embodiment described above and various configurations or embodiments can be applied within a scope not departing from the gist of the present embodiment.

All examples and condition statements aided herein are intended for educational purposes to help the reader understand the concepts contributed by the inventor to further the invention and the art, and are to be construed as not limited to such specifically aided examples and conditions, and the construction of such examples is not relevant to depicting the superiority of the invention. While embodiments of the invention have been described in detail, it is to be understood that various changes, substitutions, and modifications may be made herein without departing from the spirit and scope of the invention.

1. An information processing system comprising:
a first apparatus; and a second apparatus, wherein
the first apparatus includes
a decision unit that decides secret information, and
a first publicizing unit that publicizes a first transaction including limitation information enabling retrieving of crypto-assets by using the secret information on a distributed ledger,
the second apparatus includes
a receiving unit that receives the secret information,
a second publicizing unit that receives crypto-assets when the secret information is received by the receiving unit after the first transaction is publicized on a distributed ledger and by publicizing a second transaction including the secret information received by the receiving unit on a distributed ledger, and
an executing unit that performs a predetermined operation in response to reception of the secret information by the receiving unit.

2. The information processing system according to claim 1, wherein
the decision unit of the first apparatus decides a plural pieces of secret information,
the first publicizing unit of the first apparatus publicizes the first transaction corresponding to the plural pieces of secret information, and
as the receiving unit of the second apparatus receives a part or whole of secret information among the plural pieces of information and the second publicizing unit of the second apparatus publicizes the second transaction including the part of secret information, sending of crypto-assets related to the part of secret information is performed.

3. The information processing system according to claim 2, wherein the decision unit of the first apparatus decides the plural pieces of secret information by applying a one-way function on one piece of secret information multiple times.

4. The information processing system according to claim 1, wherein the second apparatus includes a memory unit that memorizes a use history.

5. The information processing system according to claim 1, wherein the second publicizing unit of the second apparatus publicizes the second transaction on a distributed ledger when a success probability of tampering on the first transaction has become sufficiently low.

6. An information processing apparatus comprising a processor that execute a process, the process comprising:
receiving secret information from a sending source that has publicized a first transaction including limitation information enabling retrieving of crypto-assets by using the secret information on a distribution ledger;
receiving crypto-assets when the secret information is received after the first transaction is publicized on a distributed ledger and by publicizing a second transaction including the secret information received on a distributed ledger; and
performing a predetermined operation in response to reception of the secret information.

7. An information processing method executed by a processor of information processing apparatus, the process including:
receiving secret information from a sending source that has publicized a first transaction including limitation information enabling retrieving of crypto-assets by using the secret information on a distribution ledger;
receiving crypto-assets when the secret information is received after the first transaction is publicized on a distributed ledger and by publicizing a second transaction including the secret information received on a distributed ledger; and
performing a predetermined operation in response to reception of the secret information.

8. A non-transitory computer-readable recording medium storing an information processing program causing a processor of information processing apparatus to execute an information process, the process including:
receiving secret information from a sending source that has publicized a first transaction including limitation information enabling retrieving of crypto-assets by using the secret information on a distribution ledger;
receiving crypto-assets when the secret information is received after the first transaction is publicized on a distributed ledger and by publicizing a second transaction including the secret information received on a distributed ledger; and
performing a predetermined operation in response to reception of the secret information.
